(19) United States
(12) Patent Application Publication
(10) Pub. No.: US 2011/0003071 A1
(43) Pub. Date: Jan. 6, 2011

(54) CATALYST INK COMPRISING AN IONIC LIQUID AND ITS USE IN THE PRODUCTION OF ELECTRODES, CCMS, GDES AND MEAS

(75) Inventors: Oemer Uensal, Mainz (DE); Sigmar Braeuninger, Hemsbach (DE); Xiao Steimle, Mannheim (DE); Alexander Panchenko, Ludwigshafen (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/920,229

(22) PCT Filed: Feb. 26, 2009
(86) PCT No.: PCT/EP09/52287

§ 371 Date: Aug. 30, 2010

(30) Foreign Application Priority Data
Feb. 29, 2008 (EP) 85152112.2

(51) Int. Cl. B05D 5/12; B01J 31/06; B01J 23/42; B01J 31/18

(52) U.S. Cl. 427/58; 502/159; 502/167

(57) ABSTRACT

The present invention relates to a catalyst ink comprising at least one catalytically active material and at least one ionic liquid, a process for producing this catalyst ink, a process for producing a membrane-electrode assembly (MEA) comprising at least one membrane and at least one electrode by applying this catalyst ink to a membrane or by applying this catalyst ink to any gas diffusion layer present, the use of this catalyst ink in the production of a membrane-electrode assembly (MEA), a catalyst coated membrane (CCM) or a gas diffusion electrode (GDE) and the use of an ionic liquid for producing a catalyst ink.

The present invention relates to a catalyst ink comprising at least one catalytically active material and at least one ionic liquid, a process for producing such a catalyst ink, a process for producing an MEA by applying such a catalyst ink to a membrane or to a GDL, the use of a catalyst ink in the production of an MEA and the use of an ionic liquid for producing a catalyst ink.

In fuel cells, a fuel is converted into electric power, heat and water by means of an oxidant at separate places at two electrodes. Suitable fuels are hydrogen or a hydrogen-rich gas and also liquid fuels such as methanol, ethanol, formic acid, ethylene glycol, etc., and oxygen or air are used as oxidant. The energy conversion process in the fuel cell has a high efficiency. Fuel cells are therefore gaining increasing importance, in particular in combination with electric motors as alternatives for conventional internal combustion engines. Owing to their compact construction and power density, polymer electrolyte fuel cells (PEM fuel cells) are particularly suitable for use in motor vehicles.

In general, a PEM fuel cell is made up of a stacked arrangement of membrane-electrode assemblies (MEAs), with bipolar plates usually being arranged between each two MEAs for the supply of gas and conduction of electric current. An MEA is generally made up of a polymer electrolyte membrane which is provided on each side with a catalyst layer (catalyst coated membrane, CCM) to which a gas diffusion layer (GDL) has in turn been applied in each case. Furthermore, an MEA can also be obtained by applying a gas diffusion electrode (GDE) comprising a cathode catalyst layer or an anode catalyst layer on a gas diffusion layer to each of the two sides of a membrane. One of the abovementioned catalyst layers therefore serves as anode for the oxidation of hydrogen and the second catalyst layer serves as cathode for the reduction of oxygen. The gas diffusion layers are generally made up of carbon fiber paper, woven carbon fiber fabric or carbon nonwoven and have a high porosity which allows good access of the reaction gases to the catalyst layers and allows the reaction products to be removed readily and the cell current to be taken off.

To achieve a very good bond between the polymer electrolyte membrane and the catalyst layers applied to each side with good contact between the anode or cathode at the polymer electrolyte membrane, the catalyst layers are generally each applied in the form of a catalyst ink to the membrane. It is also possible for such a catalyst ink to be applied to a GDL to produce a GDE and this GDE to be hot pressed onto an appropriate membrane. A catalyst ink generally comprises an electrocatalyst, an electron conductor, if appropriate a polymer electrolyte and a solvent.

Such catalyst inks and processes for producing them are already known from the prior art.

U.S. Pat. No. 5,330,860 discloses a process for producing a membrane-electrode assembly by application of an ink comprising catalytically active particles, a hydrocarbon having at least one ether, epoxy or ketone group and an alcohol group and, if appropriate, a binder, preferably perfluorinated sulfonyl fluoride polymers or perfluorinated sulfonic acid polymers. A preferred hydrocarbon solvent in the catalyst ink of U.S. Pat. No. 5,330,860 is 1-methoxy-2-propanol.

M. Uchida et al., J. Electrochem. Soc., Vol. 142, No. 2, 1995, pages 463 to 468, disclose a process for producing polymer electrolyte fuel cells. In this process, a catalyst ink comprising Nafion®, a catalyst comprising elemental platinum on a carbon support and a mixture of isopropanol, ethanol and specific organic solvents selected from among esters, ethers, acetone, ketones, amines, carboxylic acids, alcohols and nonpolar solvents is used.

EP 1 176 655 A1 discloses a process for producing a membrane-electrode assembly by application of a liquid composition comprising a fluoro copolymer, at least one electrocatalyst and a mixture of a solvent having a low boiling point, for example 1,1,2-trifluoro-1,2-dichloroethane, a solvent having an intermediate boiling point, for example ethanol or hexane, and a solvent having a high boiling point, for example isobutanol, n-butanol or toluene.

EP 0 731 520 A1 discloses a catalyst ink for producing membrane-electrode assemblies by printing, which comprises at least one catalytically active material, at least one proton-conducting polymer and essentially water as solvent. The catalyst ink of the EP 0 731 520 A1 comprises not more than 10% by weight of organic solvents.

WO 2004/054021 A2 discloses a catalyst ink comprising water, at least one solid catalyst, at least one polymer electrolyte in protonated form and at least one polar, aprotic organic solvent, for example dimethyl sulfoxide, N,N-dimethylacetamide, N,N-dimethylformamide, N-methylpyrrolidone and others.

In general, catalyst inks known from the prior art comprise at least one ionomer which is soluble or at least dispersible therein, at least one catalytically active material and at least one solvent selected from among organic solvents, water and mixtures thereof. A disadvantage of these catalyst inks is that the ionomers present in the catalyst inks can be inhomogeneously distributed in the electrode produced from the catalyst ink and the performance of the fuel cell is therefore reduced. Furthermore, electrodes which have been produced from the known catalyst inks often have an unsatisfactory porosity; for example, an advantageous combination of micropores and macropores is not obtained.

It is an object of the present invention to provide improved catalyst inks which make it possible to obtain electrode layers having a particularly advantageous porosity. The electrodes produced from the catalyst ink according to the invention should have both microporous and macroporous properties, since the relatively small pores increase the surface area and thereby increase the catalyst activity and utilization while the larger pores ensure mass transfer both of the substrates and of the products of the electrochemical reaction. A further object of the present invention is to provide catalyst inks which simplify or improve the production and especially the reproducibility of the production of membrane-electrode assemblies.

These objects are achieved according to the invention by a catalyst ink comprising at least one catalytically active material and at least one ionic liquid.

At least one catalytically active material is present in the catalyst ink of the invention. It is possible according to the invention for one catalytically active material to be present but it is also possible for a mixture of various catalytically active materials to be present.

Suitable catalytically active materials are preferably catalytically active metals. These are known to those skilled in the art. Suitable catalytically active metals are generally selected from the group consisting of platinum, palladium, iridium, rhodium, ruthenium and mixtures thereof, particularly preferably platinum and/or ruthenium. In a very particularly preferred embodiment, platinum alone or a mixture of platinum and ruthenium is used. It is also possible to use the polyoxymetalates known to those skilled in the art.

The catalytically active metals or mixtures of various metals which are preferably used can, if appropriate, comprise further alloying additives selected from the group consisting of cobalt, chromium, tungsten, molybdenum vanadium, iron, copper, nickel, silver, gold, iridium, tin, etc., and mixtures thereof.

In a further preferred embodiment, the at least one catalytically active material is applied to a suitable support material. Suitable support materials are known to those skilled in the art, for example electron conductors selected from the group consisting of carbon black, graphite, carbon fibers, carbon nanoparticles, carbon foams, carbon nanotubes and mixtures thereof.

Which of the abovementioned catalytically active metals is used depends on the planned field of use of the finished fuel cell. If a fuel cell which is to be operated using hydrocarbon as fuel is produced, it is sufficient for only platinum to be used as catalytically active material. A catalyst layer made up of this catalyst ink according to the invention can be used both for the anode and for the cathode in a fuel cell.

In the case of a fuel cell which is to be operated using a reformate gas comprising carbon monoxide as fuel, it is advantageous for the anode catalyst to have a very high resistance to poisoning by carbon monoxide. In such a case, preference is given to using electrocatalyts based on platinum/ruthenium. In the production of a direct methanol fuel cell, too, preference is given to using electrocatalysts based on platinum/ruthenium. Preference is therefore given to the catalyst ink according to the invention comprising both metals for the production of the anode layer in such a fuel cell. To produce the cathode layer of such a fuel cell, it is generally sufficient for platinum alone to be used as catalytically active metal.

It is possible, according to the invention, for the same catalyst ink according to the invention to be used for the coating of each side of an ion-conducting polyelectrolyte membrane in order to produce a CCM, but it is likewise possible for different catalyst inks comprising different catalytically active metals to be used for coating the two sides of a polymer electrolyte membrane. The catalyst ink of the invention can also be used for producing a GDE by coating of a GDL.

The at least one catalytically active material is generally present in the catalyst ink of the invention in an amount of from 0.1 to 3 parts by weight, preferably from 0.2 to 2 parts by weight, particularly preferably from 0.8 to 2 parts by weight, in each case based on the total catalyst ink.

The catalyst ink of the invention further comprises at least one ionic liquid.

For the purposes of the present invention, ionic liquids are preferably
(A) salts of the general formula (I)

[A]ₙ⁺[Y]ⁿ⁻ (I),
where n is 1, 2, 3 or 4, [A]⁺ is a quaternary ammonium cation, an oxonium cation, a sulfonium cation or a phosphonium cation and [Y]ⁿ⁻ is a monovalent, divalent, trivalent or tetravalent anion; or
(B) mixed salts of the general formulae (II)

[A¹]⁺[A²]⁺[Y]ⁿ⁻ (IIa), where n=2;

[A¹]⁺[A²]⁺[A³]⁺[Y]ⁿ⁻ (IIb), where n=3; or

[A¹]⁺[A²]⁺[A³]⁺[A⁴]⁺[Y]ⁿ⁻ (IIc), where n=4, and
where [A¹]⁺, [A²]⁺, [A³]⁺ and [A⁴]⁺ are selected independently from among the groups mentioned for [A]⁺ and [Y]ⁿ⁻ is as defined under (A).

The at least one ionic liquid preferably has a melting point of less than 180° C. The melting point of the at least one ionic liquid is more preferably −50° C. to 150° C., even more preferably from −20° C. to 120° C. and in particular from −20 to 100° C. In a particularly preferred embodiment, the at least one ionic liquid is liquid at room temperature, i.e. 25° C.

The ionic liquids used according to the invention are organic compounds, i.e. at least one cation or anion of the ionic liquid comprises an organic radical.

Compounds suitable for the formation of the cation [A]+of ionic liquids are known, for example, from DE 102 02 838 A1. Thus, such compounds can comprise oxygen, phosphorus, sulfur or in particular nitrogen atoms, for example at least one nitrogen atom, preferably from 1 to 10 nitrogen atoms, particularly preferably from 1 to 5 nitrogen atoms, very particularly preferably from 1 to 3 nitrogen atoms and in particular 1 or 2 nitrogen atoms. If appropriate, further heteroatoms such as oxygen or phosphorus atoms can also be comprised. The nitrogen atom is a suitable carrier of the positive charge in the cation of the ionic liquid, from which a proton or an alkyl radical can then go over in equilibrium to the anion to produce an electrically neutral molecule.

If the nitrogen atom is the carrier of the positive charge in the cation of the ionic liquid, a cation can firstly be produced by quaternization on the nitrogen atom of, for instance, an amine or nitrogen heterocycle in the synthesis of the ionic liquids. Quaternization can be effected by alkylation of the nitrogen atom. Depending on the alkylation reagent used, salts having different anions are obtained. In cases in which it is not possible to form the desired anion in the quaternization itself, this can be brought about in a further step of the synthesis. Starting from, for example, an ammonium halide, the halide can be reacted with a Lewis acid, forming a complex anion from the halide and Lewis acid. As an alternative, replacement of a halide ion by the desired anion is possible. This can be achieved by addition of a metal salt with precipitation of the metal halide formed, by means of an ion exchanger or by displacement of the halide ion by a strong acid (with liberation of the hydrogen halide). Suitable methods are described, for example, in Angew. Chem. 2000, 112, pp. 3926-3945, and the references cited therein.

Suitable alkyl radicals by means of which the nitrogen atom in the amines or nitrogen heterocycles can, for example, be quaternized are C₁-C₁₈-alkyl, preferably C₁-C₁₀-alkyl, particularly preferably C₁-C₈-alkyl and very particularly preferably methyl. The alkyl group can be unsubstituted or have one or more identical or different substituents.

Preference is given to compounds which comprise at least one five- or six-membered heterocycle, in particular a five-membered heterocycle, which has at least one nitrogen atom and also, if appropriate, an oxygen atom. Particular preference is likewise given to compounds which comprise at least one five- or six-membered heterocycle which has one, two or three nitrogen atoms and an oxygen atom, very particularly preferably compounds having two nitrogen atoms. Further preference is given to aromatic heterocycles.

Compounds which are particularly preferably used as ionic liquids have a molecular weight below 1000 g/mol, very particularly preferably below 500 g/mol.

Furthermore, preference is given to cations selected from among the compounds of the formulae (IVa) to (IVw),

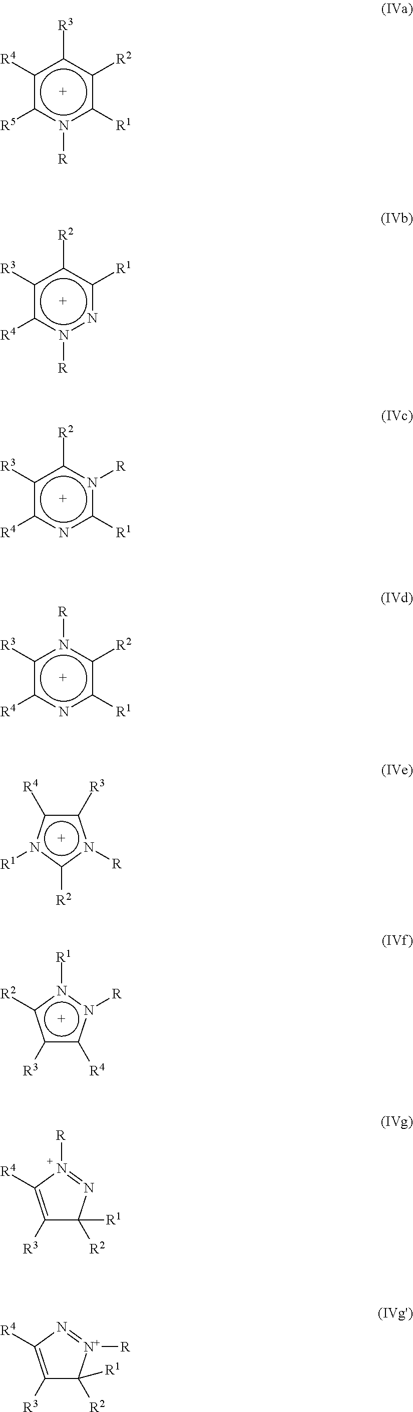

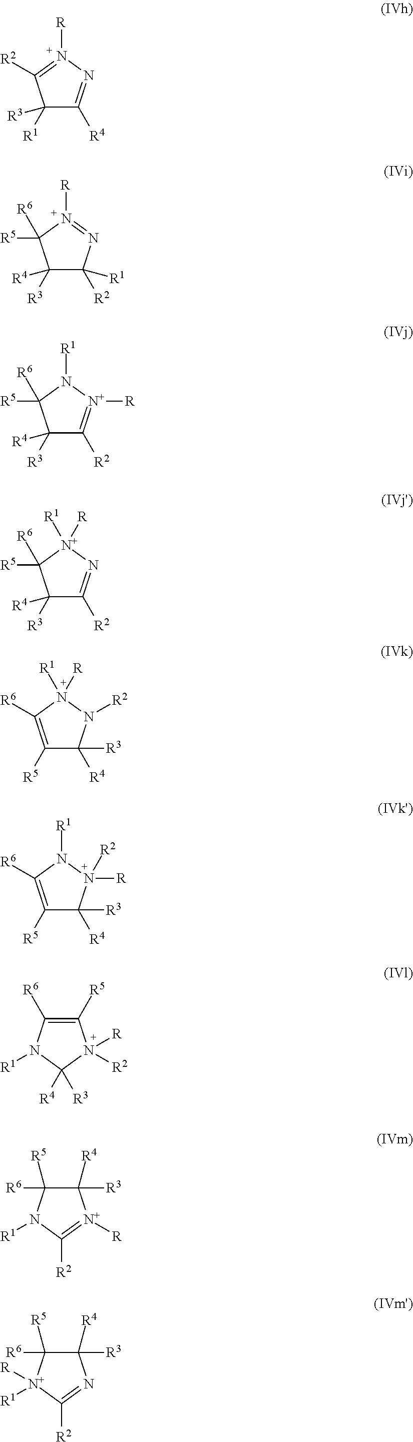

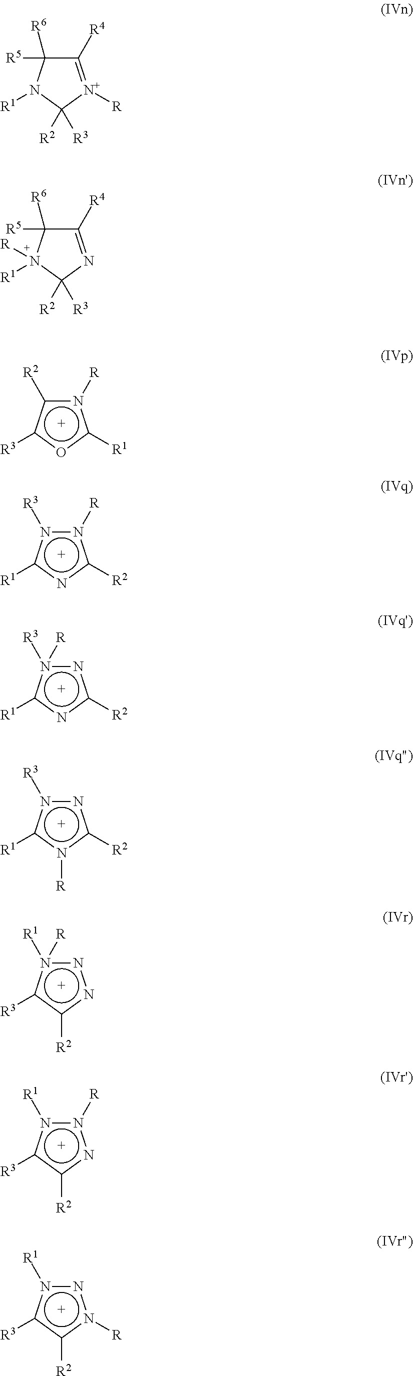

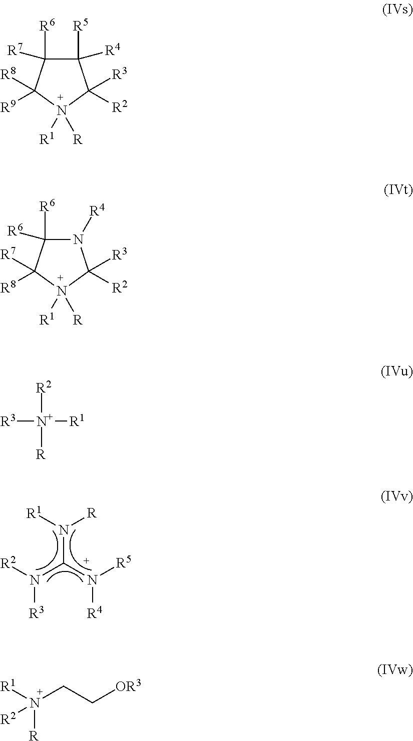

and oligomers comprising these structures.

Further suitable cations are compounds of the general formulae (IVx) and (IVy)

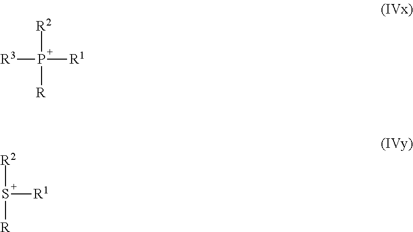

and oligomers comprising these structures.

In the abovementioned formulae (IVa) to (IVy),
the radical R is hydrogen or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups; and
the radicals R¹ to R⁹ are each, independently of one another, hydrogen, a sulfo group or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups, where the radicals R¹ to R⁹ which are bound to a carbon atom (and not to a heteroatom) in the formulae (IV) mentioned above are additionally able to be halogen or a functional group; or
two adjacent radicals from the group consisting of R¹ to R⁹ may together also form a divalent, carbon-comprising organic, saturated or unsaturated, acyclic or cyclic, aliphatic, aromatic or araliphatic radical which has from 1 to 30 carbon atoms and may be unsubstituted or be interrupted or substituted by from 1 to 5 heteroatoms or functional groups.

In the definitions of the radicals R and R¹ to R⁹, possible heteroatoms are in principle all heteroatoms which are able to formally replace a —CH₂-group, a —CH═group, a —C≡group or a ═C═ group. If the carbon-comprising radical comprises heteroatoms, then oxygen, nitrogen, phosphorus and silicon are preferred. Preferred groups are, in particular, —O—, —NR′—, —N═, —PR′—, —PR′₂ and —SiR′₂—, where the radicals R′ are the remaining part of the carbon-comprising radical. In the cases in which the radicals R¹ to R⁹ are bound to a carbon atom (and not a heteroatom) in the abovementioned formulae (IV), they can also be bound directly via the heteroatom.

Suitable functional groups are in principle all functional groups which can be bound to a carbon atom or a heteroatom. Suitable examples are —OH (hydroxy), ═O, in particular as carbonyl group, —NH₂ (amino), —NHR′, —NR₂′ ═NH (imino), —COOH (carboxy), —CONH₂ (carboxamide), —SO₃H (sulfo) and —CN (cyano). Functional groups and heteroatoms can also be directly adjacent, so that combinations of a plurality of adjacent atoms, for instance —O— (ether), —COO— (ester), —CONN— (secondary amide) or —CONR′— (tertiary amide), are also comprised, for example di(C₁-C₄-alkyl)amino, C₁-C₄-alkyloxycarbonyl or C₁-C₄-alkyloxy. The radicals R′ are the remaining part of the carbon-comprising radical.

A halogen is, for example, fluorine.

The radical R is preferably
unbranched or branched C₁-C₁₈-alkyl which may be unsubstituted or substituted by one or more hydroxy, halogen, phenyl, cyano, C₁-C₆-alkoxycarbonyl and/or SO₃H groups and has a total of from 1 to 20 carbon atoms, for example methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, benzyl, 3-phenylpropyl, 2-hydroxyethyl, 2-cyanoethyl, 2-(methoxycarbonyl)ethyl, 2-(ethoxycarbonyl)ethyl, 2-(n-butoxycarbonyl)ethyl, trifluoromethyl, difluoromethyl, fluoromethyl, pentafluoroethyl, heptafluoropropyl, heptafluoroisopropyl, nonafluorobutyl, nonafluoroisobutyl, undecyifluoropentyl, undecylfluoroisopentyl, 6-hydroxyhexyl and propylsulfonic acid,
glycols, butylene glycols and oligomers thereof having from 1 to 100 units and a hydrogen or a C₁-C₈-alkyl as end group, for example R^{A}O—(CHR^{B}—CH₂—O)ₙ—CHR^{B}—CH₂— or R^{A}O—(CH₂CH₂CH₂CH₂O)ₙ—CH₂CH₂CH₂CH₂O— where R^{A} and R^{B} are preferably hydrogen, methyl or ethyl and n is preferably from 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxatridecyl and 3,6,9,12-tetraoxatetradecyl,
vinyl,
1-propen-1-yl, 1-propen-2-yl and 1-propen-3-yl, and
N,N-di-C₁-C₆-alkylamino such as N,N-dimethylamino and N,N-diethylamino.

The radical R is particularly preferably unbranched and unsubstituted C₁-C₁₈-alkyl such as methyl, ethyl, 1-propyl, 1-butyl, 1-pentyl, 1-hexyl, 1-heptyl, 1-octyl, 1-decyl, 1-dodecyl, 1-tetradecyl, 1-hexadecyl, 1-octadecyl, in particular methyl, ethyl, 1-butyl and 1-octyl, or CH₃O—(CH₂CH₂O)ₙ—CH₂CH₂— and CH₃CH₂O—(CH₂CH₂O)ₙ—CH₂CH₂— where n is from 0 to 3.

Preference is given to the radicals R¹ to R⁹ each being, independently of one another,
hydrogen,
fluorine,
a functional group,
C₁-C₁₈-alkyl which may optionally be substituted by functional groups, aryl, alkyl, aryloxy, alkyloxy, halogen, heteroatoms and/or heterocycles and/or be interrupted by one or more oxygen atoms and/or one or more substituted or unsubstituted imino groups,
C₂-C₁₈-alkenyl which may optionally be substituted by functional groups, aryl, alkyl, aryloxy, alkyloxy, halogen, heteroatoms and/or heterocycles and/or be interrupted by one or more oxygen atoms and/or one or more substituted or unsubstituted imino groups,
C₆-C₁₂-aryl which may optionally be substituted by functional groups, aryl, alkyl, aryloxy, alkyloxy, halogen, heteroatoms and/or heterocycles,
C₅-C₁₂-cycloalkyl which may optionally be substituted by functional groups, aryl, alkyl, aryloxy, alkyloxy, halogen, heteroatoms and/or heterocycles,
C₅-C₁₂-cycloalkenyl which may optionally be substituted by functional groups, aryl, alkyl, aryloxy, alkyloxy, halogen, heteroatoms and/or heterocycles, or
a five- or six-membered, oxygen- and/or nitrogen-comprising hetereocycle which may optionally be substituted by functional groups, aryl, alkyl, aryloxy, alkyloxy, halogen, heteroatoms and/or heterocycles, or
   two adjacent radicals together with the atoms to which they are bound for
an unsaturated, saturated or aromatic ring which may optionally be substituted by functional groups, aryl, alkyl, aryloxy, alkyloxy, halogen, heteroatoms and/or heterocycles and may optionally be interrupted by one or more oxygen atoms and/or one or more substituted or unsubstituted imino groups.

C₁-C₁₈-Alkyl which may optionally be substituted by functional groups, aryl, alkyl, aryloxy, alkyloxy, halogen, heteroatoms and/or heterocycles is preferably methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, 2-ethylhexyl, 2,4,4-trimethylpentyl, 1,1,3,3-tetramethylbutyl, 1-nonyl, 1-decyl, 1-undecyl, 1-dodecyl, 1-tridecyl, 1-tetradecyl, 1-pentadecyl, 1-hexadecyl, 1-heptadecyl, 1-octadecyl, cyclopentylmethyl, 2-cyclopentylethyl, 3-cyclopentylpropyl, cyclohexylmethyl, 2-cyclohexylethyl, 3-cyclohexylpropyl, benzyl (phenylmethyl), diphenylmethyl (benzhydryl), triphenylmethyl, 1-phenylethyl, 2-phenylethyl, 3-phenylpropyl, α,α-dimethylbenzyl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di-(methoxycarbonyl)ethyl, methoxy, ethoxy, formyl, 1,3-dioxolan-2-yl, 1,3-dioxan-2-yl, 2-methyl-1,3-dioxolan-2-yl, 4-methyl-1,3-dioxolan-2-yl, 2-hydroxyethyl, 2-hydroxypropyl, 3-hydroxypropyl, 4-hydroxybutyl, 6-hydroxyhexyl, 2-aminoethyl, 2-aminopropyl, 3-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl, 6-ethoxyhexyl, acetyl, CₙF_{2(n-a)+(1-b)}H_{2a+b} where n is from 1 to 30, 0≦a≦n and b=0 or 1 (for example CF₃, C₂F₅, CH₂CH₂—C₍ₙ₋₂₎F₂₍ₙ₋₂₎₊₁, C₆F₁₃, C₈F₁₇, C₁₀F₂₁, C₁₂F₂₅), chloromethyl, 2-chloroethyl, trichloromethyl, 1,1-dimethyl-2-chloroethyl, methoxymethyl, 2-butoxyethyl, diethoxymethyl, diethoxyethyl, 2-isopropoxyethyl, 2-butoxypropyl, 2-octyloxyethyl, 2-methoxyisopropyl, 2-(methoxycarbonyl)ethyl, 2-(ethoxycarbonyl)ethyl, 2-(n-butoxycarbonyl)ethyl, butylthiomethyl, 2-dodecylthioethyl, 2-phenylthioethyl, 5-hydroxy-3-oxapentyl, 8-hydroxy-3,6-dioxaoctyl , 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-dioxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-dioxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl. C₂-C₁₈-Alkenyl which may optionally be substituted by functional groups, aryl, alkyl, aryloxy, alkyloxy, halogen, heteroatoms and/or heterocycles and/or be interrupted by one or more oxygen atoms and/or one or more substituted or unsubstituted imino groups is preferably vinyl, 2-propenyl, 3-butenyl, cis-2-butenyl, trans-2-butenyl or CₙF_{2(n-a)-(1-b)}H_{2a-b} where n≦30, 0≦a≦n and b=0 or 1.

C₆-C₁₂-Aryl which may optionally be substituted by functional groups, aryl, alkyl, aryloxy, alkyloxy, halogen, heteroatoms and/or heterocycles is preferably phenyl, tolyl, xylyl, α-naphthyl, β-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2-nitrophenyl, 4-nitrophenyl, 2,4-dinitrophenyl, 2,6-dinitrophenyl, 4-dimethylaminophenyl, 4-acetylphenyl, methoxyethylphenyl, ethoxymethylphenyl, methylthiophenyl, isopropylthiophenyl or tert-butylthiophenyl or C₈F₍₅₋ₐ₎Hₐ where 0≦a≦5.

C₅-C₁₂-Cycloalkyl which may optionally be substituted by functional groups, aryl, alkyl, aryloxy, alkyloxy, halogen, heteroatoms and/or heterocycles is preferably cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl, CₙF_{2(n-a)-(1-b)}H_{2a-b} where n≦30, 0≦a≦n and b=0 or 1, or a saturated or unsaturated bicyclic system such as norbornyl or norbornenyl.

C₅-C₁₂-Cycloalkenyl which may optionally be substituted by functional groups, aryl, alkyl, aryloxy, alkyloxy, halogen, heteroatoms and/or heterocycles is preferably 3-cyclopentenyl, 2-cyclohexenyl, 3-cyclohexenyl, 2,5-cyclohexadienyl or CₙF_{2(n-a)-3(1-b)}H_{2a-3b} where n≦30, 0≦a≦n and b=0 or 1.

A five- or six-membered, oxygen- and/or nitrogen-comprising heterocycle which may optionally be substituted by functional groups, aryl, alkyl, aryloxy, alkyloxy, halogen, heteroatoms and/or heterocycles is preferably furyl, pyrryl, pyridyl, indolyl, benzoxazolyl, dioxolyl, dioxyl, benzimidazolyl, dimethylpyridyl, methylquinolyl, dimethylpyrryl, methoxyfuryl, dimethoxypyridyl or difluoropyridyl.

If two adjacent radicals together form an unsaturated, saturated or aromatic ring which may optionally be substituted by functional groups, aryl, alkyl, aryloxy, alkyloxy, halogen, heteroatoms and/or heterocycles and may optionally be interrupted by one or more oxygen atoms and/or one or more substituted or unsubstituted imino groups, they preferably form 1,3-propylene, 1,4-butylene, 1,5-pentylene, 2-oxa-1,3-propylene, 1-oxa-1,3-propylene, 2-oxa-1,3-propylene, 1-oxa-1,3-propenylene, 3-oxa-1,5-pentylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

If the abovementioned radicals comprise oxygen atoms and/or substituted or unsubstituted imino groups, the number of oxygen atoms and/or imino groups is not subject to any restrictions. In general, there will be no more than 5 in the radical, preferably no more than 4 and very particularly preferably no more than 3.

If the abovementioned radicals comprise heteroatoms, there is generally at least one carbon atom, preferably at least two carbon atoms, between any two heteroatoms.

Particular preference is given to the radicals R¹ to R⁹ each being, independently of one another,
hydrogen,
unbranched or branched C₁-C₁₈-alkyl which may be unsubstituted or substituted by one or more hydroxy, halogen, phenyl, cyano, C₁-C₆-alkoxycarbonyl and/or SO₃H groups and has a total of from 1 to 20 carbon atoms, for example methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, benzyl, 3-phenylpropyl, 2-hydroxyethyl, 2-cyanoethyl, 2-(methoxycarbonyl)ethyl, 2-(ethoxy-carbonyl)ethyl, 2-(n-butoxy-carbonyl)ethyl, trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylfluoroisopentyl, 6-hydroxyhexyl and propylsulfonic acid;
glycols, butylene glycols and oligomers thereof having from 1 to 100 units and a hydrogen or a C₁-C₈-alkyl radical as end group, for example R^{A}O—(CHR^{B}—CH₂—O)ₙ—CHR^{B}—CH₂— or R^{A}O—(CH₂CH₂CH₂CH₂O)ₙ—CH₂CH₂CH₂CH₂O— where R^{A} and R^{B} are each preferably hydrogen, methyl or ethyl and n is preferably 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxatridecyl and 3, 6,9, 12-tetraoxatetradecyl;
vinyl;
1-propen-1-yl, 1-propen-2-yl and 1-propen-3-yl; and
N,N-di-C₁-C₆-alkylamino such as N,N-dimethylamino and N,N-diethylamino.

Very particular preference is given to the radicals R¹ to R⁹ each being, independently of one another, hydrogen or C₁-C₁₈-alkyl such as methyl, ethyl, 1-butyl, 1-pentyl, 1-hexyl, 1-heptyl, 1-octyl, phenyl, 2-hydroxyethyl, 2-cyanoethyl, 2-(methoxycarbonyl)ethyl, 2-(ethoxycarbonyl)ethyl, 2-(n-butoxycarbonyl)ethyl, N,N-dimethylamino, N,N-diethylamino, chlorine or CH₃O—(CH₂CH₂O)ₙ—CH₂CH₂— and CH₃CH₂O—(CH₂CH₂O)ₙ—CH₂CH₂— where n is from 0 to 3.

Very particularly preferred pyridinium ions (IVa) are those in which
one of the radicals R¹ to R⁵ is methyl or ethyl and the remaining radicals R¹ to R⁵ are each hydrogen;
R³ is dimethylamino and the remaining radicals R¹, R², R⁴ and R⁵ are each hydrogen;
all radicals R¹ to R⁵ are hydrogen;
R² is carboxamide and the remaining radicals R¹, R², R⁴ and R⁵ are each hydrogen; or
R¹ and R² or R² and R³ are 1,4-buta-1,3-dienylene and the remaining radicals R¹, R², R⁴ and R⁵ are each hydrogen;
   and in particular those in which
R¹ to R⁵ are each hydrogen; or
one of the radicals R¹ to R⁵ is methyl or ethyl and the remaining radicals R¹ to R⁵ are each hydrogen.

Very particularly preferred pyridinium ions (IVa) are selected from the group consisting of 1-methylpyridinium, 1-ethylpyridinium, 1-(1-butyl)pyridinium, 1-(1-hexyl)pyridinium, 1-(1-octyl)pyridinium, 1-(1-hexyl)pyridinium, 1-(1-octyl)pyridinium, 1-(1-dodecyl)pyridinium, 1-(1-tetradecyl)pyridinium, 1-(1-hexadecyl)pyridinium, 1,2-dimethyl-pyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium and 1-(1-octyl)-2-methyl-3-ethylpyridinium, 1-(1- dodecyl)-2-methyl-3-ethylpyridinium, 1-(1-tetradecyl)-2-methyl-3-ethylpyridinium , hexadecyl)-2-methyl-3-ethylpyridinium and mixtures thereof.

Very particularly preferred pyridazinium ions (IVb) are those in which
R¹ to R⁴ are each hydrogen, or
one of the radicals R¹ to R⁴ is methyl or ethyl and the remaining radicals R¹ to R⁴ are each hydrogen.

Very particularly preferred pyrimidinium ions (IVc) are those in which
R¹ is hydrogen, methyl or ethyl and R² to R⁴ are each, independently of one another, hydrogen or methyl, or
R¹ is hydrogen, methyl or ethyl, R² and R⁴ are each methyl and R³ is hydrogen.

Very particularly preferred pyrazinium ions (IVd) are those in which
R¹ is hydrogen, methyl or ethyl and R² to R⁴ are each, independently of one another, hydrogen or methyl,
R¹ is hydrogen, methyl or ethyl, R² and R⁴ are each methyl and R³ is hydrogen,
R¹ to R⁴ are each methyl, or
R¹ to R⁴ are each hydrogen.

Very particularly preferred imidazolium ions (IVe) are those in which
R¹ is hydrogen, methyl, ethyl, 1-propyl, 1-butyl, 1-pentyl, 1-hexyl, 1-octyl, 2-hydroxyethyl or 2-cyanoethyl and R² to R⁴ are each, independently of one another, hydrogen, methyl or ethyl.

Very particularly preferred imidazolium ions (IVe) are selected from the group consisting of 1-methylimidazolium, 1-ethylimidazolium, 1-(1-butyl)imidazolium, 1-(1-octyl)imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-butyl)-3-ethylimidazolium, -hexyl)-3-methyl-imidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methyl-imidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, -hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 3-butylimidazolium, 1,4-dimethyl-3-octylimidazolium, 1,4,5-trimethylimidazolium, 1,3,4,5-tetramethyl-imidazolium, 1,4,5-trimethyl-3-ethylimidazolium, 1,4,5-trimethyl-3-butylimidazolium, 1,4,5-trimethyl-3-octylimidazolium and 1-(prop-1-en-3-yl)-3-methylimidazolium.

Very particularly preferred pyrazolium ions (lVf), (IVg) and (IVg′) are those in which
R¹ is hydrogen, methyl or ethyl and R² to R⁴ are each, independently of one another, hydrogen or methyl.

Very particularly preferred pyrazolium ions (IVh) are those in which
R¹ to R⁴ are each, independently of one another, hydrogen or methyl.

Very particularly preferred 1-pyrazolinium ions (IVi) are those in which
R¹ to R⁶ are each, independently of one another, hydrogen or methyl.

Very particularly preferred 2-pyrazolinium ions (IVj) and (IVF) are those in which
R¹ is hydrogen, methyl, ethyl or phenyl and R² to R⁶ are each, independently of one another, hydrogen or methyl.

Very particularly preferred 3-pyrazolinium ions (IVk) and (IVk′) are those in which
R¹ and R² are each, independently of one another, hydrogen, methyl, ethyl or phenyl and R³ to R⁶ are each, independently of one another, hydrogen or methyl.

Very particularly preferred imidazolinium ions (IVI) are those in which
R¹ and R² are each, independently of one another, hydrogen, methyl, ethyl, 1-butyl or phenyl, R³ and R⁴ are each, independently of one another, hydrogen, methyl or ethyl and R⁵ and R⁶ are each, independently of one another, hydrogen or methyl.

Very particularly preferred imidazolinium ions (IVm) and (IVm′) are those in which
R¹ and R² are each, independently of one another, hydrogen, methyl or ethyl and R³ to R⁶ are each, independently of one another, hydrogen or methyl.

Very particularly preferred imidazolinium ions (IVn) and (IVn′) are those in which
R¹ to R³ are each, independently of one another, hydrogen, methyl or ethyl and R⁴ to R⁶ are each, independently of one another, hydrogen or methyl.

Very particularly preferred 1,2,4-triazolium ions (IVq), (IVq′) and (IVq″) are those in which
R¹ and R² are each, independently of one another, hydrogen, methyl, ethyl or phenyl and R³ is hydrogen, methyl or phenyl.

Very particularly preferred 1,2,3-triazolium ions (IVr), (IVr′) and (IVr“) are those in which
R¹ is hydrogen, methyl or ethyl and R² and R³ are each, independently of one another, hydrogen or methyl or R² and R³ are together 1,4-buta-1,3-dienylene.

Very particularly preferred pyrrolidinium ions (IVs) are those in which
R¹ is hydrogen, methyl, ethyl or phenyl and R² to R⁹ are each, independently of one another, hydrogen or methyl.

Very particularly preferred imidazolidinium ions (IVt) are those in which
R¹ and R⁴ are each, independently of one another, hydrogen, methyl, ethyl or phenyl and R² and R³ and also R⁵ to R⁸ are each, independently of one another, hydrogen or methyl.

Very particularly preferred ammonium ions (IVu) are those in which
R¹ to R³ are each independently of one another, C₁— to C₁₈-alkyl or
R¹ and R² are together 1,5-pentylene or 3-oxa-1,5-pentylene and R³ is C₁-C₁₈-alkyl, 2-hydroxyethyl or 2-cyanoethyl.

As very particularly preferred ammonium ions (IVu), mention may be made of methyl-tri(1-butyl)ammonium, N,N-dimethylpiperidinium and N,N-dimethylmorpholinium.

Examples of tertiary amines from which the quaternary ammonium ions of the general formula (IVu) are derived by quaternization with the radicals R mentioned are diethyl-n-butylamine, diethyl-tert-butylamine, diethyl-n-pentylamine, diethylhexylamine, diethyloctylamine, diethyl(2-ethylhexyl)amine, di-n-propylbutylamine, di-n-propyl-n-pentylamine, di-n-propylhexylamine, di-n-propyloctylamine, di-n-propyl(2-ethyl-hexyl)amine, diisopropylethylamine, diisopropyl-n-propylamine, diisopropylbutylamine, diisopropylpentylamine, diisopropylhexylamine, diisopropyloctylamine, diisopropyl(2-ethylhexyl)amine, di-n-butylethylamine, di-n-butyl-n-propylamine, di-n-butyl-n-pentylamine, di-n-butylhexylamine, di-n-butyloctylamine, di-n-butyl(2-ethylhexyl)amine, N-n-butylpyrrolidine, N-sec-butylpyrrolidine, N-tert-butylpyrrolidine, N-n-pentylpyrrolidine, N,N-dimethylcyclohexylamine, N,N-diethylcyclohexylamine, N,N-di-n-butylcyclohexylamine, N-n-propylpiperidine, N-isopropylpiperidine, N-n-butylpiperidine, N-sec-butylpiperidine, N-tert-butylpiperidine, N-n-pentylpiperidine, N-n-butylmorpholine, N-sec-butylmorpholine, N-tert-butylmorpholine, N-n-pentylmorpholine, N-benzyl-N-ethylaniline, N-benzyl-N-n-propylaniline, N-benzyl-N-isopropylaniline, N-benzyl-N-n-butylaniline, N,N-dimethyl-p-toluidine, N,N-diethyl-p-toluidine, N,N-di-n-butyl-p-toluidine, diethylbenzylamine, di-n-propylbenzylamine, di-n-butylbenzylamine, diethylphenylamine, di-n-propylphenylamine and di-n-butylphenylamine.

Preferred quaternary ammonium salts of the general formula (IVu) are those which can be derived from the following tertiary amines by quaternization by means of the radicals R mentioned, e.g. diisopropylethylamine, diethyl-tert-butylamine, diisopropylbutylamine, di-n-butyl-n-pentylamine, N,N-di-n-butylcyclohexylamine and tertiary amines derived from pentyl isomers.

Particularly preferred tertiary amines are di-n-butyl-n-pentylamine and tertiary amines derived from pentyl isomers. A further preferred tertiary amine which has three identical radicals is triallylamine.

Very particularly preferred guanidinium ions (IVv) are those in which
R¹ to R⁵ are each methyl.

As very particularly preferred guanidinium ion (IVv), mention may be made of N,N,N′,N′,N″,N″-hexamethylguanidinium.

Very particularly preferred cholinium ions (IVw) are those in which
R¹ and R² are each, independently of one another, methyl, ethyl, 1-butyl or 1-octyl and R³ is hydrogen, methyl, ethyl, acetyl, —SO₂OH or —PO(OH)₂,
R¹ is methyl, ethyl, 1-butyl or 1-octyl, R² is a —CH₂—CH₂—OR⁴ group and R³ and R⁴ are each, independently of one another, hydrogen, methyl, ethyl, acetyl, —SO₂OH or —PO(OH)₂, or —R¹ is a —CH₂—CH₂—OR⁴ group, R² is a —CH₂—CH₂—OR⁵ group and R³ to R⁵ are each, independently of one another, hydrogen, methyl, ethyl, acetyl, —SO₂OH or —PO(OH)₂.

Particularly preferred cholinium ions (IVw) are those in which R³ is selected from among hydrogen, methyl, ethyl, acetyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl and 14-ethoxy-5,10-oxatetradecyl.

Very particularly preferred phosphonium ions (IVx) are those in which
R¹ to R³ are each, independently of one another, C₁-C₁₈-alkyl, in particular butyl, isobutyl, 1-hexyl or 1-octyl.

Among the abovementioned heterocyclic cations, preference is given to the pyridinium ions, pyrazolinium ions, pyrazolium ions and the imidazolinium ions and the imidazol-ium ions. Preference is also given to ammonium ions.

Particular preference is given to 1-methylpyridinium, 1-ethylpyridinium, 1-(1-butyl)pyridinium, 1-(1-hexyl)pyridinium, 1-(1-octyl)pyridinium, 1-(1-hexyl)pyridinium, 1-(1-octyl)pyridinium, 1-(1-dodecyl)pyridinium, 1-(1-tetradecyl)pyridinium, 1-(1-hexa-decyl)pyridinium, 1,2-dimethylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dode-cyl)-2-ethylpyridinium, 1-(1-tetradecyl)-2-ethylpyridinium, 1 -(1-hexadecyl)-2-ethyl-pyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium, 1-(1-octyl)-2-methyl-3-ethylpyridinium, 1-(1-dodecyl)-2-methyl-3-ethylpyridinium, 1-(1-tetradecyl)-2-methyl-3-ethylpyridinium, 1-(1-hexadecyl)-2-methyl-3-ethylpyridinium, 1-methyl-imidazolium, 1-ethylimidazolium, 1-(1-butyl)imidazolium, 1-(1-octyl)imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-hexyl)-3-methylimidazolium, 1-(1-octyl)-3-methylimidazolium, 1-(1-dodecyl)-3-methylimidazolium, 1-(1-tetradecyl)-3-methylimidazolium, 1-(1-hexadecyl)-3-methylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium and 1-(1-octyl)-2,3-dimethylimidazolium, 1,4-dimethylimidazolium, 1,3,4-trimethylimidazolium, 1,4-dimethyl-3-ethylimidazolium, 3-butylimidazolium, 1,4-dimethyl-3-octylimidazolium, 1,4,5-trimethylimidazolium, 1,3,4,5-tetrarnethylimidazolium, 1,4,5-trimethyl-3-ethylimidazolium, 1,4,5-trimethyl-3-butylimidazolium, 1,4,5-trimethyl-3-octylimidazolium and 1-(prop-1-en-3-yl)-3-methylimidazolium, very particularly preferably 1-ethyl-2,3-dimethylimidazolium.

As anions, it is in principle possible to use all anions.

The anion [Y]ⁿ⁻ of the ionic liquid is, for example, selected from
the group consisting of F⁻, BF₄⁻, PF₆⁻, CF₃SO₃⁻, (CF₃SO₃)₂N⁻, CF₃CO₂⁻, CCl₃CO₂⁻ and mixtures thereof,
the group of sulfates, sulfites and sulfonates of the general formulae: SO₄²⁻, HSO₄⁻, SO₃²⁻, HSO₃⁻, R^{a}OSO₃⁻, R^{a}SO₃⁻ and mixtures thereof,
the group of phosphates of the general formulae: PO₄³⁻, HPO₄²⁻, H₂PO₄⁻, R^{a}PO₄²⁻, HR^{a}PO₄⁻, R^{a}R^{b}PO₄⁻ and mixtures thereof,
the group of phosphonates and phosphinates of the general formulae: R^{a}HPO₃⁻, R^{a}R^{b}PO₂⁻, R^{a}R^{b}PO₃⁻ and mixtures thereof,
the group of phosphites of the general formulae: PO₃³⁻, HPO₃²⁻, H₂PO₃⁻, R^{a}PO₃²⁻, R^{a}HPO₃⁻, R^{a}R^{b}PO₃⁻ and mixtures thereof,
the group of phosphonites and phosphinites of the general formulae: R^{a}R^{b}PO₂⁻, R^{a}HPO₂⁻, R^{a}R^{b}PO⁻, R^{a}HPO⁻ and mixtures thereof,
the group of carboxylic acids of the general formula: R^{a}COO⁻ and mixtures thereof,
the group of borates of the general formulae: BO₃³⁻, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻, B(HSO₄)⁻, B(R^{a}SO₄)⁻ and mixtures thereof,
the group of boronates of the general formulae: R^{a}BO₂²⁻, R^{a}R^{b}BO⁻ and mixtures thereof,
the group of carbonates and carbonic esters of the general formulae: HCO₃⁻, CO₃²⁻, R^{a}CO₃⁻ and mixtures thereof,
the group of silicates and silicic esters of the general formulae: SiO₄⁴⁻, HSO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻ and mixtures thereof,
the group of alkylsilane and arylsilane salts of the general formulae: R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}SiO₂⁻, R^{a}R^{b}SiO₃²⁻ and mixtures thereof,
the group of carboximides, bis(sulfonyl)imides, sulfonylimides and cyanamide of the general formulae:

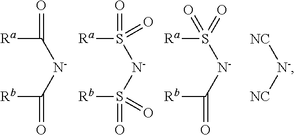

the group of methides of the general formula:

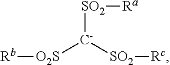

the group of alkoxides and aryloxides of the general formula: R^{a}O⁻ and mixtures thereof,
the group of halometalates of the general formula [M_{q}Halᵣ]^{s-}, where M is a metal and Hal is fluorine, q and r are positive integers and indicate the stoichiometry of the complex and s is a positive integer and indicates the charge of the complex, and mixtures thereof,
the group of complex metal ions such as Fe(CN)₆³⁻, Fe(CN)₆⁴⁻, MnO₄₋, Fe(CO)₄⁻ and mixtures thereof.

Here, R^{a}, R^{b}, R^{c} and R^{d} are each, independently of one another, hydrogen, C₁-C₃₀-alkyl, C₂-C₁₈-alkyl which may optionally be interrupted by one or more nonadjacent oxygen and/or sulfur atoms and/or one or more substituted or unsubstituted imino groups, C₆-C₁₄-aryl, C₅-C₁₂-cycloalkyl or a five- or six-membered, oxygen-, nitrogen- and/or sulfur-comprising heterocycle, where two of them may also together form an unsaturated, saturated or aromatic ring which may optionally be interrupted by one or more oxygen and/or sulfur atoms and/or one or more unsubstituted or substituted imino groups, where the radicals mentioned may each be additionally substituted by functional groups, aryl, alkyl, aryloxy, alkyloxy, halogen, heteroatoms and/or heterocycles.

Here, C₁-C₁₈-alkyl which may optionally be substituted by functional groups, aryl, alkyl, aryloxy, alkyloxy, halogen, heteroatoms and/or heterocycles is, for example, methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, hexadecyl, octadecyl, 1,1-dimethylpropyl, 1,1-dimethylbutyl, 1,1,3,3-tetramethylbutyl, benzyl, 1-phenylethyl, α,α-dimethylbenzyl, benzhydryl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di-(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylthioethyl, 2,2,2-trifluoroethyl, 2-hydroxyethyl, 2-hydroxypropyl, 3-hydroxypropyl, 4-hydroxybutyl, 6-hydroxyhexyl, 2-aminoethyl, 2-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylamino-butyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl.

C₂-C₁₈-alkyl which may optionally be interrupted by one or more nonadjacent oxygen and/or sulfur atoms and/or one or more substituted or unsubstituted imino groups is, for example, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-oxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxa-pentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

If two radicals form a ring, these radicals can together form as fused-on building block, for example, 1,3-propylene, 1,4-butylene, 2-oxa-1,3-propylene, 1-oxa-1,3-propylene, 2-oxa-1,3-propenylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

The number of nonadjacent oxygen and/or sulfur atoms and/or imino groups is in principle not subject to any restrictions or is automatically restricted by the size of the radical or the cyclic building block. In general, there will be no more than 5 in the respective radical, preferably no more than 4 and very particularly preferably no more than 3. Furthermore, there is generally at least one carbon atom, preferably at least two carbon atoms, between any two heteroatoms.

Substituted and unsubstituted imino groups can be, for example, imino, methylimino, isopropylimino, n-butylimino or tert-butylimino.

The term “functional groups” refers, for example, to the following: carboxy, carboxamide, hydroxyl, di(C₁-C₄-alkyl)amino, C₁-C₄-alkyloxycarbonyl, cyano or C₁-C₄-alkoxy. Here, C₁-C₄alkyl is methyl, ethyl, propyl, isopropyl, n-butyl, sec-butyl or tert-butyl.

C₆-C₁₄-Aryl which may optionally be substituted by functional groups, aryl, alkyl, aryloxy, alkyloxy, halogen, heteroatoms and/or heterocycles is, for example, phenyl, tolyl, xylyl, α-naphthyl, β-naphthyl, 4-diphenylyl, chlorophenyl, dichlorophenyl, trichlorophenyl, difluorophenyl, methylphenyl, dimethylphenyl, trimethylphenyl, ethyl-phenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl.

C₅-C₁₂-Cycloalkyl which may optionally be substituted by functional groups, aryl, alkyl, aryloxy, halogen, heteroatoms and/or heterocycles is, for example, cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl or a saturated or unsaturated bicyclic system such as norbornyl or norbornenyl.

A five- or six-membered, oxygen-, nitrogen- and/or sulfur-comprising heterocycle is, for example, furyl, thiophenyl, pyrryl, pyridyl, indolyl, benzoxazolyl, dioxolyl, dioxyl, benzimidazolyl, benzthiazolyl, dimethylpyridyl, methyiquinolyl, dimethylpyrryl, methoxyfuryl, dimethoxypyridyl, difluoropyridyl, methylthiophenyl, isopropylthiophenyl or tert-butylthiophenyl.

Particularly preferred anions are selected from the group consisting of F⁻, BF₄⁻, PF₆⁻, CF₃SO₃⁻, (CF₃SO₃)₂N⁻, CF₃CO₂⁻, from the group of sulfates, sulfites and sulfonates of the general formulae: SO₄²⁻, HSO₄⁻, SO₃²⁻, HSO₃⁻, R^{a}OSO₃⁻, R^{a}SO₃⁻, from the group of phosphates of the general formulae PO₄³⁻, HPO₄²⁻, H₂PO₄⁻, R^{a}PO₄²⁻, from the group of borates of the formulae BO₃³⁻, HBO₃²⁻, H₂BO₃⁻, from the group of silicates and silicic esters of the formulae SiO₄⁴⁻, HSiO₄³⁻, H₂SiO₄²⁻, H₃SiO₄⁻, of carboximides, bis(sulfonyl)imides and sulfonylimides of the general formulae depicted above and mixtures thereof, where R^{a} and R^{b} is particularly preferably selected from among methyl, ethyl, propyl and butyl.

In a particularly preferred embodiment, ionic liquids of the formula I in which [A]⁺ is 1-ethyl-2,3-dimethylimidazolium and [Y]⁺ is ethyl sulfate, i.e. 1-ethyl-2,3-dimethylimidazolium ethyl sulfate, are used.

In a preferred embodiment, at least one organic solvent and/or water is/are present in addition to the at least one ionic liquid in the catalyst ink of the invention.

Suitable solvents are those which are, on the basis of the prior art, known to those skilled in the art as being suitable for use in catalyst inks. Examples of suitable organic solvents are selected from the group consisting of monohydric and polyhydric alcohols, nitrogen-comprising polar solvents, glycols, glycol ether alcohols, glycol ethers and mixtures thereof. Particularly suitable solvents are, for example, propylene glycol, dipropylene glycol, glycerol, ethylene glycol, hexylene glycol, dimethylacetamide (DMAc), dimethylformamide (DMF), N-methylpyrrolidone (NMP), n-propanol and mixtures thereof. In a further embodiment of the process of the invention, water can also be present in the catalyst ink of the invention.

If at least one organic solvent and water are present in addition to the at least one ionic liquid in the catalyst ink of the invention, this mixture is present in an amount of generally from 0.1 to 5 parts by weight, preferably from 0.8 to 4 parts by weight, particularly preferably from 1 to 3 parts by weight, in each case based on the total catalyst ink. The at least one organic solvent is generally present in an amount of from 0.1 to 5 parts by weight, preferably from 0.5 to 2.5 parts by weight, particularly preferably from 1 to 2 parts by weight, in each case based on the total catalyst ink. Water is generally present in an amount of from 1 to 4 parts by weight, preferably from 1 to 3.5 parts by weight, particularly preferably from 1 to 3 parts by weight, in each case based on the total catalyst ink.

Apart from the abovementioned components, at least one ionomer, preferably an ionomer having acidic properties, is generally present in the catalyst ink of the invention. The ionomers dispersed in the catalyst ink of the invention are known to those skilled in the art and are disclosed, for example, in WO-A 03/054991.

Preference is given to using at least one ionomer having sulfonic acid, carboxylic acid and/or phosphonic acid groups and salts thereof. Suitable ionomers having sulfonic acid, carboxylic acid and/or phosphonic acid groups are likewise known to those skilled in the art. For the purposes of the present invention, sulfonic acid, carboxylic acid and/or phosphonic acid groups are groups of the formulae —SO₃X, —COOX and —PO₃X₂, where X is H, NH₄⁺, NH₃R′⁺, NH₂R′₃⁺, NHR′₃⁺, NR′₄⁺, Na⁺, K⁺ or Li⁺ and R′ is any radical, preferably an alkyl radical, which may optionally bear one or more further radicals, for example one or more perfluorinated radicals, which can release protons under conditions usually prevailing in fuel cells.

Preferred ionomers are, for example, polymers comprising sulfonic acid groups selected from the group consisting of perfluorinated sulfonated hydrocarbons such as Nafion® from E. I. DuPont, sulfonated aromatic polymers such as sulfonated polyaryl ether ketones such as polyether ether ketones (sPEEK), sulfonated polyether ketones (sPEK), sulfonated polyether ketone ketones (sPEKK), sulfonated polyether ether ketone ketones (sPEEKK), sulfonated polyether ketone ether ketone ketone (sPEKEKK), sulfonated polyarylene ether sulfones, sulfonated polybenzobisbenzazoles, sulfonated polybenzothiazoles, sulfonated polybenzimidazoles, sulfonated polyamides, sulfonated polyether imides, sulfonated polyphenylene oxides, e.g. poly-2,6-dimethyl-1,4-phenylene oxides, sulfonated polyphenylene sulfides, sulfonated phenol-formaldehyde resins (linear or branched), sulfonated polystyrenes (linear or branched), sulfonated polyphenylenes and further sulfonated aromatic polymers. The sulfonated aromatic polymers can be partially fluorinated or perfluorinated.

Further sulfonated polymers comprise polyvinylsulfonic acids, copolymers made up of acrylonitrile and 2-acrylamido-2-methyl-1-propanesulfonic acids, acrylonitrile and vinylsulfonic acids, acrylonitrile and styrenesulfonic acids, acrylonitrile and methacryloxyethylenoxypropanesulfonic acids, acrylonitrile and methacryloxyethylenoxytetrafluoroethylenesulfonic acids, etc. The polymers can again be partially fluorinated or perfluorinated. Further groups of suitable sulfonated polymers comprise sulfonated polyphosphazenes such as poly(sulfophenoxy)phosphazenes or poly(sulfoethoxy)phosphazenes. The polyphosphazene polymers can be partially fluorinated or perfluorinated. Sulfonated polyphenylsiloxanes and copolymers thereof, poly(sulfoalkoxy)phosphazenes, poly(sulfotetrafluoroethoxypropoxy)siloxanes are likewise suitable.

Examples of suitable polymers comprising carboxylic acid groups comprise polyacrylic acid, polymethacrylic acid and any copolymers thereof. Suitable polymers are, for example, copolymers with vinylimidazole or acrylonitrile. The polymers can again be partially fluorinated or perfluorinated.

Suitable polymers comprising phosphonic acid groups are, for example, polyvinylphosphonic acid, polybenzimidazolephosphonic acid, phosphonated polyphenylene oxides, e.g. poly-2,6-dimethylphenylene oxides, etc. The polymers can be partially fluorinated or perfluorinated. Apart from cation-conducting, i.e. acid, polymers, anion-conducting, i.e. basic, polymers are also conceivable, but in this case the proportion of acidic ionomers has to predominate. These bear, for example, tertiary amine groups or quaternary ammonium groups. Examples of such polymers are described in U.S. Pat. No. 6,183,914; JP-A 11273695 and in Slade et al., J. Mater. Chem. 13 (2003), 712-721.

Furthermore, acid-based blends as are disclosed, for example, in WO 99/54389 and WO 00/09588 are suitable as ionomers. These are generally polymer mixtures comprising a polymer comprising sulfonic acid groups and a polymer having primary, secondary or tertiary amino groups, as are disclosed in WO 99/54389, or polymer mixtures obtained by mixing polymers which comprise basic groups in the side chain with polymers comprising sulfonate, phosphonate or carboxylate groups, in the acid or salt form. Suitable polymers comprising sulfonate, phosphonate or carboxylate groups have been mentioned above; see polymers comprising sulfonic acid, carboxylic acid or phosphonic acid groups. Polymers comprising basic groups in the side chain are polymers which are obtained by side chain modification of aryl main chain engineering polymers which can be deprotonated by means of organometallic compounds with arylene-comprising N-basic groups, by reacting aromatic ketones and aldehydes comprising tertiary basic nitrogen groups, for example tertiary amine or heterocyclic aromatic compounds comprising basic nitrogen, e.g. pyridine, pyrimidine, triazine, imidazole, pyrazole, triazole, thiazole, oxazole, etc., with the metalated polymer. Here, the metal alkoxide formed as intermediate can, in a further step, either be protonated by means of water or etherified by means of haloalkanes (WO0/09588).

The abovementioned ionomers can also be crosslinked. Suitable crosslinking reagents are, for example, epoxide crosslinkers such as the commercially available Decanoles®. Suitable solvents in which crosslinking can be carried out can be selected, inter alia, as a function of the crosslinking reagent and the ionomers used. Suitable solvents are, inter alia, aprotic solvents such as DMAc (N,N-dimethylacetamide), DMF (dimethylformamide), NMP (N-methylpyrrolidone) or mixtures thereof. Suitable crosslinking processes are known to those skilled in the art.

Preferred ionomers are the abovementioned polymers comprising sulfonic acid groups. Particular preference is given to perfluorinated sulfonated hydrocarbons such as Nafion®, sulfonated aromatic polyether ether ketones (sPEEK), sulfonated polyether ether sulfones (sPES), sulfonated polyether imides, sulfonated polybenzimidazoles, sulfonated polyether sulfones and mixtures of the polymers mentioned. Particular preference is given to perfluorinated sulfoncated hydrocarbons such as Nafion® and sulfonated polyether ether ketones (sPEEK). These can be used either alone or in mixtures with other ionomers. It is likewise possible to use copolymers which comprise blocks of the abovementioned polymers, preferably polymers comprising sulfonic acid groups. An example of such a block copolymer is sPEEK-PAMD.

The degree of functionalization of the ionomers comprising sulfonic acid, carboxylic acid and/or phosphonic acid groups is generally from 0 to 100%, preferably from 0.1 to 100%, more preferably from 30 to 70%, particularly preferably from 40 to 60%.

Sulfonated polyether ether ketones which are particularly preferably used have degrees of sulfonation of from 0 to 100%, more preferably from 0.1 to 100%, even more preferably from 30 to 70%, particularly preferably from 40 to 60%. Here, a sulfonation of 100% or a functionalization of 100% means that each repeating unit of the polymer comprises a functional group, in particular a sulfonic acid group.

The polyazoles described in relation to the membrane materials can also be present as ionomers in the ink of the invention.

The abovementioned ionomers can be used either alone or in mixtures in the catalyst inks of the invention. It is possible to use mixtures which comprise, in addition to the at least one ionomer, further polymers or other additives, e.g. inorganic materials, catalysts or stabilizers.

Methods of preparing the abovementioned ion-conducting polymers which are suitable as ionomers are known to those skilled in the art. Suitable processes for preparing sulfonated polyaryl ether ketones are disclosed, for example, in EP-A 0 574 791 and WO 2004/076530.

Some of the ion-conducting polymers (ionomers) mentioned are commercially available, e.g. Nafion® from E. I. DuPont. Further suitable commercially available materials which can be used as ionomers are perfluorinated and/or partially fluorinated polymers such as “Dow Experimental Membrane” (Dow Chemicals USA), Aciplex® (Asahi Chemicals, Japan), Raipure R-1010 (Pall Rai Manufacturing Co. USA), Flemion (Asahi Glas, Japan) and Raymion® (Chlorin Engineering Cop., Japan).

The at least one ionomer is generally present in the catalyst ink of the invention in an amount of from 0.5 to 4 parts by weight, preferably from 1 to 3 parts by weight, particularly preferably from 1.0 to 2.5 parts by weight, in each case based on the total catalyst ink.

In addition to the components mentioned, the catalyst ink of the invention can comprise further additives, for example wetting agents, leveling agents, antifoams, pore formers, stabilizers, pH modifiers and other substances.

Furthermore, the catalyst ink of the invention preferably comprises at least one electron-conducting component comprising at least one electron conductor. Suitable electron conductors are known to those skilled in the art. In general, the electron conductor comprises electrically conductive carbon particles. As electrically conductive carbon particles, it is possible to use all carbon materials which are known in the field of fuel or electrolysis cells and have a high electrical conductivity and large surface area. Preference is given to using carbon blacks, graphite, carbon nanotubes or activated carbons.

The present invention also provides a process for producing the catalyst ink of the invention by mixing at least one catalytically active material and at least one ionic liquid.

In a preferred embodiment of this process, a catalyst ink comprising at least one ionomer, at least one organic solvent and/or water and at least one ionic liquid is mixed with at least one catalytically active material. This mixing can be carried out by all methods known to those skilled in the art, for example in apparatuses known to those skilled in the art, for example stirred reactors, shaken ball mixers or continuous mixing devices, if appropriate using ultrasound.

Mixing is, according to the invention, carried out at a temperature at which the processability of the individual components is ensured and the ionic liquid is present in liquid form or as a solution in a solvent. Suitable solvents have been mentioned above. Suitable temperatures are, for example, from 0 to 150° C., preferably from 20 to 120° C. The process of the invention for producing the catalyst ink of the invention can be carried out at any pressure at which the components present are processible; in particular, the process of the invention is carried out at a pressure at which the ionic liquid is liquid, for example from 1 bar to 10 bar, preferably from 1 to 5 bar.

The weight ratio of catalytically active material to at least one ionomer to at least one organic solvent and/or water is 0.5-1.5:1.5-2.5:0.5-4, preferably 0.8-1.2:1.8-2.2:0.8-3.2, particularly preferably 1:2:1-3. This mixture comprising catalytically active material, ionomer and organic solvent and/or water is then admixed with from 0.01 to 1 part by weight of ionic liquid, preferably from 0.05 to 0.8 part by weight of ionic liquid, in each case based on the mixture comprising catalytically active material, ionomer and organic solvent and/or water.

Furthermore, the catalyst ink of the invention can comprise at least one binder. This binder is, for example, selected from among fluorine-comprising polymers, for example polytetrafluoroethylene, poly(fluoroethylenepropylene), polyvinylidene fluoride (PVdF) and mixtures thereof. In general, the weight ratio of catalytically active substance to binder is from 10:1 to 1:10, preferably from 8:1 to 1:8, particularly preferably from 7:2 to 2:7, for example from 6:2 to 6:4.

Furthermore, the present invention also provides a process for producing a membrane-electrode assembly (MEA) comprising at least one membrane, at least one electrode and, if appropriate, at least one gas diffusion layer by applying the catalyst ink of the invention to a membrane or by applying the catalyst ink of the invention to any gas diffusion layer present.

The membrane is generally made up of all materials which are known to be suitable by those skilled in the art, for example the ionomers which have been mentioned above. These membranes are suitable for fuel cells having an operating temperature of up to 100° C.

Suitable membranes for use in fuel cells at temperatures above 100° C. up to about 200° C. are, for example, the membranes based on polyazoles and H₃PO₄ which are known to those skilled in the art, for example as described in EP 1 379 573, EP 1 427 517, EP 1 379 573 and EP 1 425 336.

The polyazol-based polymers used comprise recurring azole units of the general formula (I) and/or (II)

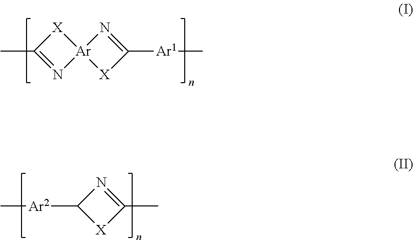

where
the radicals Ar are identical or different and are each a tetravalent aromatic or heteroaromatic, monocyclic or polycyclic group,
the radicals Ar¹ are identical or different and are each a divalent aromatic or heteroaromatic, monocyclic or polycyclic group,
the radicals Ar² are identical or different and are each a divalent or trivalent aromatic or heteroaromatic, monocyclic or polycyclic group and
the radicals X are identical or different and are each oxygen, sulfur or an amino group which bears a hydrogen atom, a group having 1-20 carbon atoms, preferably a branched or unbranched alkyl or alkoxy group, or an aryl group as further radical.

Preferred aromatic or heteroaromatic groups are derived from benzene, naphthalene, biphenyl, diphenyl ether, diphenylmethane, diphenyldimethylmethane, bisphenone, diphenyl sulfone, quinoline, pyridine, bipyridine, anthracene and phenanthrene, each of which may optionally be substituted.

Here, Ar¹ can have any substitution pattern; in the case of phenylene, Ar¹ can be, for example, ortho-, meta- or para-phenylene. Particularly preferred groups are derived from benzene and biphenyls, each of which may optionally be substituted.

Preferred alkyl groups are short-chain alkyl groups having from 1 to 4 carbon atoms, e.g. methyl, ethyl, n- or i-propyl and t-butyl groups.

Preferred aromatic groups are phenyl or naphthyl groups. The alkyl groups and the aromatic groups can be substituted.

Preferred substituents are halogen atoms such as fluorine, amino groups or short-chain alkyl groups such as methyl or ethyl groups.

Preference is given to polyazoles having recurring units of the formula (I) in which the radicals X are identical within a recurring unit.

The polyazoles can in principle also have different recurring units which differ, for example, in their radical X. However, they preferably have only identical radicals X in a recurring unit.

In a further embodiment of the present invention, the polymer comprising recurring azole units is a copolymer comprising at least two units of the formula (I) and/or (II) which differ from one another.

In a particularly preferred embodiment of the present invention, the polymer comprising recurring azole units is a polyazole comprising only units of the formula (I) and/or (II).

The number of recurring azole units in the polymer is preferably an integer greater than or equal to 10. Particularly preferred polymers comprise at least 100 recurring azole units.

For the purposes of the present invention, preference is given to polymers comprising recurring benzimidazole units. The preferred polyazoles, but in particular the polybenzimidazoles, have a high molecular weight. Measured as intrinsic viscosity, this is at least 0.2 dl/g, preferably from 0.2 to 3 dl/g.

Further preferred polyazole polymers are polyimidazoles, polybenzothiazoles, polybenzoxazoles, polyoxadiazoles, polyquinoxalines, polythiadiazoles, poly(pyridines), poly(pyrimidines) and poly(tetrazapyrenes).

Such polybenzimidazoles (PBIs) are usually prepared as described in EP 1 379 573 by reacting, for example, 3,3′,4,4′-tetraaminobiphenyl with isophthalic acid or diphenyl-isophthalic acid or esters thereof in the melt. The prepolymer formed solidifies in the reactor and is subsequently broken up mechanically. The pulverulent prepolymer is subsequently polymerized to completion in a solid-phase polymerization at temperatures of up to 400° C. to give the desired polybenzimidazoles. To produce polymer films, the PBI is, in a further step, dissolved in polar, aprotic solvents such as dimethylacetamide (DMAc) and a film is produced by means of methods known to those skilled in the art. For operation in a fuel cell, this membrane has to be made capable of conducting ions by impregnation with H₃PO₄.

If the catalyst ink of the invention is firstly applied to a suitable polymer electrolyte membrane, a CCM (catalyst coated membrane) is obtained and this produces, after application of at least one gas diffusion layer GDL, an MEA. It is also possible, according to the invention, to apply the catalyst ink to at least one gas diffusion layer GDL to form a gas diffusion electrode (GDE) which after application of a membrane gives an MEA. Processes for combining the individual layers are known to those skilled in the art, for example hot pressing or adhesive bonding.

In general, the catalyst ink of the invention is applied in homogeneously dispersed form to the ion-conducting polymer electrolyte membrane or gas diffusion layer to produce an MEA. To produce a homogeneously dispersed ink, it is possible to use known aids, for example high-speed stirrers, ultrasound and/or ball mills.

The homogenized ink can subsequently be applied to an ion-conducting polymer electrolyte membrane by means of various techniques, for example printing, spraying, doctor blade coating, rolling, brushing and painting, screen printing, ink jet printing, etc.

As a result of application of the catalyst ink of the invention, at least part of the ionic liquid present is enclosed in the pores of the polymer electrolyte membrane. In a preferred embodiment, the process of the invention for producing an MEA comprises dipping the coated polymer electrolyte membrane into an aqueous bath, preferably water or dilute acid, for example dilute H₂SO₄ or dilute HNO₃, having a concentration of, for example, from 0.2 to 1,2 mol*l⁻¹, preferably 0.5 or 1.0 mol*l⁻¹, at a temperature of from RT to 100° C., preferably from 60 to 100° C., particularly preferably 80° C. In this dipping step, most of the ionic liquid, for example up to more than 90% by weight, is washed out. The ionic liquid which has not been washed out then contributes to the ion conductivity of the finished MEA.

In a preferred embodiment, the polymer electrolyte membrane to which the catalyst ink of the invention has been applied is subsequently conditioned, for example at from room temperature, i.e. 25° C., to 100° C. In the case of a GDE, the temperature can also be from room temperature to 200° C.

The present invention therefore also provides the use of the catalyst ink of the invention in the production of a membrane-electrode assembly (MEA), a catalyst coated membrane (CCM) or a gas diffusion electrode (GDE).

The present invention also provides for the use of an ionic liquid for producing a catalyst ink.

As regards preferred embodiments of the processes and uses according to the invention, reference may be made to those relating to the catalyst ink of the invention.

The present invention is illustrated by the following examples.

### EXAMPLES

### Example 1

### Catalyst Comprising an Ionic Liquid (IL) (EMIMEtOSO3)

One part by weight of catalyst (PtRu/C, Pt: 42% by weight, Ru: 32% by weight) is stirred with 50 parts by weight of EMIMEtOSO3 at room temperature and subsequently filtered off with suction. The sample is thoroughly washed a number of times with DI water and filtered off with suction. The sample which has been dried overnight at 40° C. under reduced pressure is then analyzed for N and S. The results are summarized in Table 1.

TABLE 1
Result of the N and S analysis:

| | S [g/100 g] | N [g/100 g] |
|---|---|---|
| Referene (Catalyst) | 0.01 | <0.001 |
| Catalyst treated with IL | 0.84 | 0.7 |

### Example 2

### Production of the Anode Ink Without IL

Two parts by weight of Nafion ionomer in H₂O (10% strength by weight) (EW1100, from DuPont) and one part by weight of dimethylacetamide (DMAc) are placed in a glass bottle and stirred up by means of a magnetic stirrer. One part by weight of catalyst (PtRu/C, Pt: 42% by weight, Ru: 32% by weight) is then weighed in and slowly mixed into the mixture by stirring. The mixture is stirred at room temperature for about 5-10 minutes more by means of the magnetic stirrer. The sample is then treated with ultrasound until the energy introduced is 0.015 KWh. This value is based on a batch size of 20 g.

### Example 3

### Production of the Anode Ink with IL (EMIMEtOSO3)

Two parts by weight of Nafion ionomer in H₂O (10% strength by weight) (EW1100, from DuPont), two parts by weight of dimethylacetamide (DMAc) and x (x=0.1; 0.25; 0.5) part by weight of EMIMEtOSO3 are placed in a glass bottle and stirred up by means of a magnetic stirrer. One part of catalyst (PtRu/C, Pt: 42% by weight, Ru: 32% by weight) is then weighed in and slowly mixed into the mixture by stirring. The mixture is stirred at room temperature for about 5-10 minutes more by means of the magnetic stirrer. The sample is treated with ultrasound until the energy introduced is 0.015 KWh. This value is based on a batch size of 20 g.

### Example 4

### Production of the Cathode Ink

One part by weight of catalyst (Pt/C Pt: 70% by weight), two parts by weight of Nafion and three parts by weight of water are weighed into a glass bottle. Fox milling beads (1-1.2 mm) are then mixed into the mixture and the bottle is shaken well by hand. The weight of the milling beads corresponds to half of the total mixture. The ink is dispersed for 60 minutes in a shaking ball mixer (Skandex) at setting 3. The ink is separated off from the milling beads by sieving. Five parts by weight of n-propanol (based on the amount after filtration) are subsequently added while stirring and the mixture is stirred on a magnetic stirrer at 500 rpm for 10 minutes.

### Example 5

### Production and Cell Measurement of CCM

Catalyst coated membranes (CCMs) are produced by screen printing the anode ink onto the anode side and spraying the cathode ink onto the cathode side. The sPEEK membranes used (degree of sulfonation=43%) are in the Na salt form. The active area is 25 cm². The CCMs are then activated in 0.5 molar HNO₃ at 55° C. for two hours. The samples are subsequently dried at room temperature.

For the cell tests on the CCMs produced in this way, gas diffusion layers of the type 21BA from SGL are used on the anode side and gas diffusion layers H2315 IX11 from Freudenberg are used on the cathode side. The specimens are tested at 70° C., 1M MeOH, anode stoichiometry 3 (at least 49 ml/h), cathode stoichiometry 3 (at least 130 ml/min of air). The power densities of the specimens at 0.3 A/cm² are compared in table 2.

TABLE 2
Power density of the specimens at 0.3 A/cm²

| | | Power density |
|---|---|---|
| Specimen | IL content | [mW/cm²] |
| number | (EMIMEtOSO3) | at 0.3 A/cm² |
| Specimen 1 | 0 | 111 |
| Specimen 2 | 0.1 | 113 |
| Specimen 3 | 0.25 | 116 |
| Specimen 4 | 0.5 | 122 |

1. A catalyst ink comprising
at least one catalytically active material,
at least one ionomer,
at least one ionic liquid, and
at least one organic solvent and/or water,
wherein 0.01 to 1 parts by weight ionic liquid, with respect of a mixture comprising the at least one catalytically active material, the at least one ionomer, and organic solvent and/or water are present.

2. The catalyst ink according to claim 1, wherein the at least one catalytically active material is at least one catalytically active metal selected from the group consisting of platinum, palladium, iridium, rhodium, and ruthenium.

3. The catalyst ink according to claim 1, wherein the melting point of the at least one ionic liquid is in a range from −50° C. to 150° C.

4. The catalyst ink according to claim 1, wherein the at least one ionic liquid is liquid at room temperature.

5. The catalyst ink according to claim 1, wherein the at least one ionic liquid is 1-ethyl-2,3-dimethylimidazolium ethylsulfate.

6. The catalyst ink according to claim 1, wherein the at least one organic solvent is at least one selected from the group consisting of monohydric and polyhydric alcohols, nitrogen-comprising polar solvents, glycols, glycol ether alcohols, and glycol ethers.

7. A process for producing a catalyst ink according to claim 1, comprising:
mixing at least one catalytically active material;
at least one ionomer;
at least one ionic liquid;
and at least one organic solvent and/or water,
to obtain a catalyst ink or catalyst ink precursor.

8. A process for producing a membrane-electrode assembly (MEA) comprising at least one membrane and at least one electrode, the process comprising applying the catalyst ink according to claim 1 to a membrane or to any gas diffusion layer present.

9. A process for producing a catalyst coated membrane (CCM) or a gas diffusion electrode (GDE), comprising applying the catalyst ink of claim 1 to a membrane or any gas diffusion layer present.

10. The catalyst ink according to claim 2, wherein the melting point of the at least one ionic liquid is in a range from −50° C. to 150° C.

11. The catalyst ink according to claim 2, wherein the at least one ionic liquid is liquid at room temperature.

12. The catalyst ink according to claim 3, wherein the at least one ionic liquid is liquid at room temperature.

13. The catalyst ink according to claim 10, wherein the at least one ionic liquid is liquid at room temperature.

14. The catalyst ink according to claim 2, wherein the at least one ionic liquid is 1-ethyl-2,3-dimethylimidazolium ethylsulfate.

15. The catalyst ink according to claim 3, wherein the at least one ionic liquid is 1-ethyl-2,3-dimethylimidazolium ethylsulfate.

16. The catalyst ink according to claim 10, wherein the at least one ionic liquid is 1-ethyl-2,3-dimethylimidazolium ethylsulfate.

17. The catalyst ink according to claim 4, wherein the at least one ionic liquid is 1-ethyl-2,3-dimethylimidazolium ethylsulfate.

18. The catalyst ink according to claim 11, wherein the at least one ionic liquid is 1-ethyl-2,3-dimethylimidazolium ethylsulfate.

19. The catalyst ink according to claim 12, wherein the at least one ionic liquid is 1-ethyl-2,3-dimethylimidazolium ethylsulfate.

20. The catalyst ink according to claim 13, wherein the at least one ionic liquid is 1-ethyl-2,3-dimethylimidazolium ethylsulfate.
